(19) United States
(12) Patent Application Publication
(10) Pub. No.: US 2003/0143882 A1
(43) Pub. Date: Jul. 31, 2003

(54) Slot connector equipped with a retain structure

(76) Inventor: Nelson Tsai, Hsi Chih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/057,904

(22) Filed: Jan. 29, 2002

(51) Int. Cl. H01R 13/62

(52) U.S. Cl. 439/327

(57) ABSTRACT

A connector equipped with a retain structure includes at least a retain section and a latch means located respectively on two ends of a slot. The latch means includes a depress ledge and a latch arm extending respectively from two sides of one end of the slot, and a latch slot located between the depress ledge and the latch arm. The latch arm is movable by the depress ledge. After an interface card is inserted in the latch slot, the retain section and latch means can prevent the interface card from the possibility of moving a displacement in the vertical direction. The latch means allows users to latch the interface card in the latch slot in a most labor-saving fashion to prevent users from wrongful operations and damaging device elements.

### BACKGROUND OF THE INVENTION

1. Field of the Invention

This invention relates to a slot connector that has a retain structure and particularly to a slot connector for effectively retaining an inserted interface card.

2. Description of the Prior Art

In the age of thriving technology development and progress these days, consumers' demands on technology products are not limited to functionality, but increasingly focus on aesthetic considerations. For instance, computer casings used to have a lot of connector slots for anchoring various types of connector interface cards. In the past, an interface card inserted in a slot needs a latch means to anchor on the slot connector to prevent the interface card from shaking or loosening off from the slot. With continuous evolutions of new main boards and novel technologies, more and more producers adopt internal built-in fastening structures rather than external fastenings to anchor the interface cards. Such a change not only makes the back side of computer main boards looks more appealing, it also simplifies fabrication processing for computer casings.

Conventional latch means mostly can restrict the horizontal movement of the interface card once it is inserted in the slot. However there is no harness on the vertical movement. To prevent the interface card from loosening off from the slot requires an additional mechanism.

### SUMMARY OF THE INVENTION

In view of aforesaid disadvantages, it is therefore a primary object of this invention to provide a retain structure to restrict the interface card from moving vertically once inserted in a slot.

Another object of the invention is provides a most labor-saving means to latch and unlatch an interface card on and from the slot to prevent users from operating wrongfully and damaging device elements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a perspective view of the present invention;

FIG. 1B is another perspective view of the present invention;

FIG. 2A is a top view of the present invention;

FIG. 2B is a side view of the present invention;

FIG. 3 is a schematic view of the present invention with an interface card;

FIG. 4A is a schematic top view of the present invention, for disengaging an interface card; and

FIG. 4B is a schematic side view of the present invention, for disengaging an interface card.

### DETAILED DESCRIPTION OF THE PREFERRED EMBODIMENT

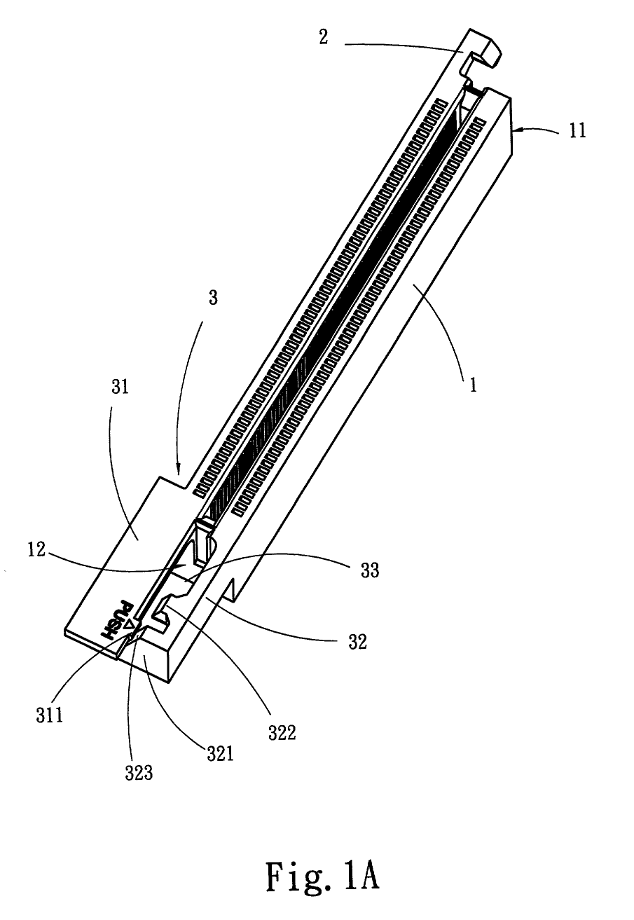

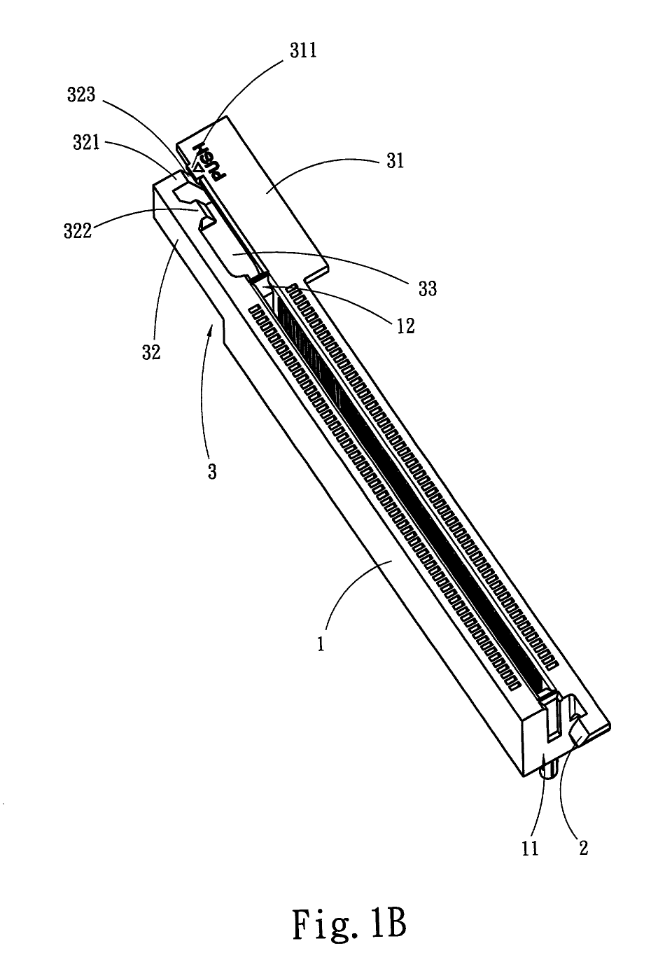

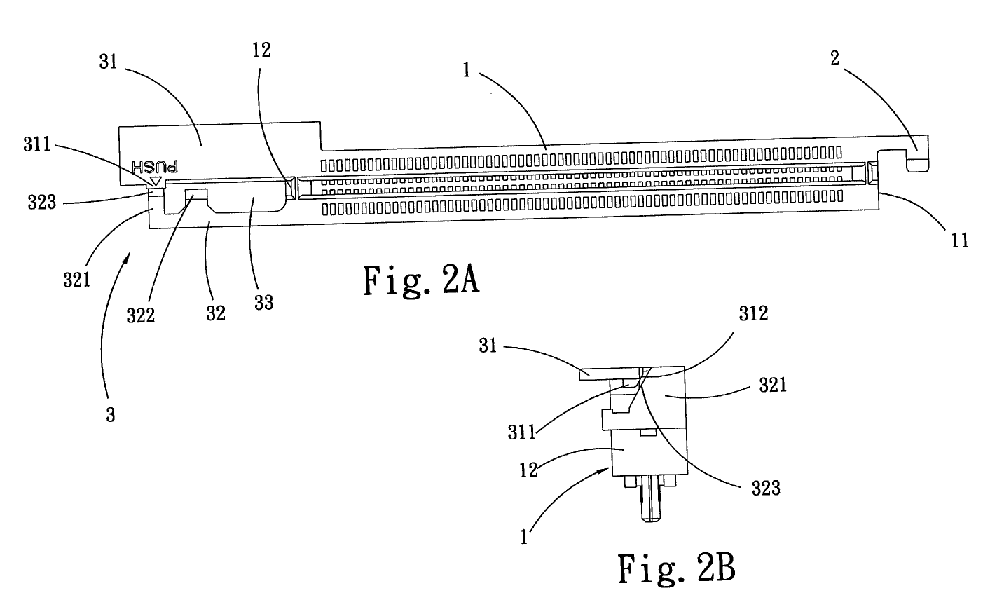

Referring to FIGS. 1A and 1B, 2A and 2B, the slot connector according to the invention has a retain structure which includes a retain section 2 and a latch means 3 located respectively on a first end 11 and a second end 12 of a slot 1. The latch means 3 includes a depress ledge 31 and a latch arm 32 extending respectively from two sides of the second end 12, and a latch slot 33 located between the depress ledge 31 and the latch arm 32. The latch arm 32 may be driven and moved by the depress ledge 31.

The depress ledge 31 and the latch arm 32 are respectively formed in a cantilever fashion and have suitable resilient property for oscillating to a desired degree. The depress ledge 31 further has a suitable area to allow users to depress with force.

The depress ledge 31 and the latch arm 32 have respectively an inner side facing the latch slot 33. On the inner side of the depress ledge 31, there is a bucking stub 311, and on the inner side of the latch arm 32, there is a bucking head 321 corresponding to the bucking stub 311. The inner side of the latch arm 32 further has a jutting retain strut 322 formed between the bucking head 321 and the second end 12. The retain strut 322 has a biased surface. The bucking head 321 has a first chamfer surface 323 of a selected gradient facing the bucking stub 311. The bucking stub 311 has a second chamfer surface 312 matching the first chamfer surface 323.

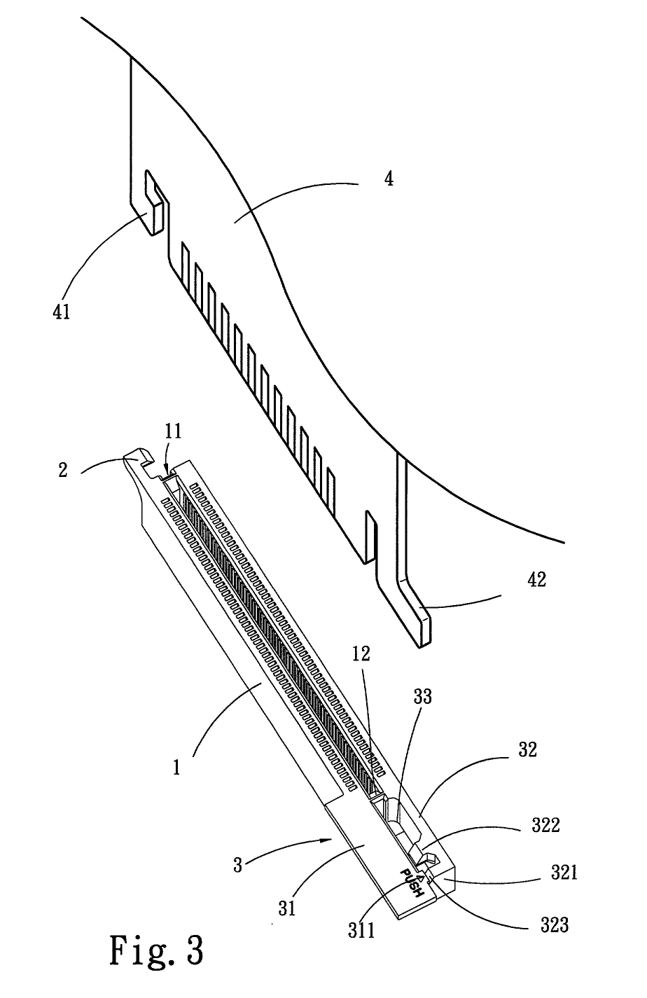

As previously discussed, in the past, the interface card inserted in a slot needs a latch means to anchor on the main casing to prevent the interface card from shaking or loosening off. With continuous evolutions of new main boards and novel technologies, more and more producers adopt internal built-in fastening structures rather than external fastenings for the interface cards. Experiences obtained from practical use show that when an interface card is inserted in a slot, it cannot be moved horizontally. However there is no harness on the vertical movement. To prevent the interface card from loosening off from the slot, adding a harness means to restrict the interface card from moving vertically is necessary. Referring to FIG. 3, the invention aims to prevent the interface card from moving vertically, and employs a retain structure to match the interface card of the prevailing main stream.

Based on aforesaid discussions, a current prevailing interface card 4 (taking an AIMM specification as an example) has a first latch end 41 and a second latch end 42 formed on two ends thereof to engage with the slot 1. When the interface card 4 is inserted in the slot 1, the first and second latch ends 41, 42 enter respectively in the retain section 2 and latch means 3. The first latch end 41 has an inverse hook to engage with the retain section 2. It is known in the art, thus is omitted here. The second latch end 42 is inserted in the latch slot 33 of the latch means 3. After the second latch end 42 is fully inserted in the latch slot 33, the bottom section of the retain strut 322 is latched and contacts on the top surface of the second latch end 42, therefore can prevent the interface card 4 from the possibility of moving a displacement in the vertical direction. During insertion of the interface card 4 in the latch slot 33, the interface card 4 first contacts the retain strut 322. Because of the biased surface on the retain strut 322, the interface card 4 can be smoothly inserted into the latch slot 33.

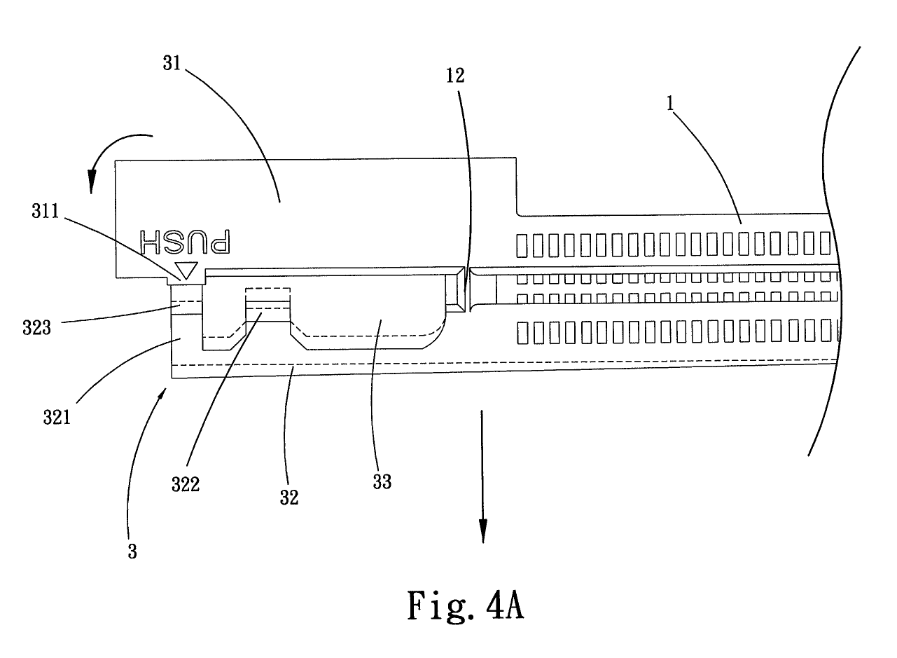

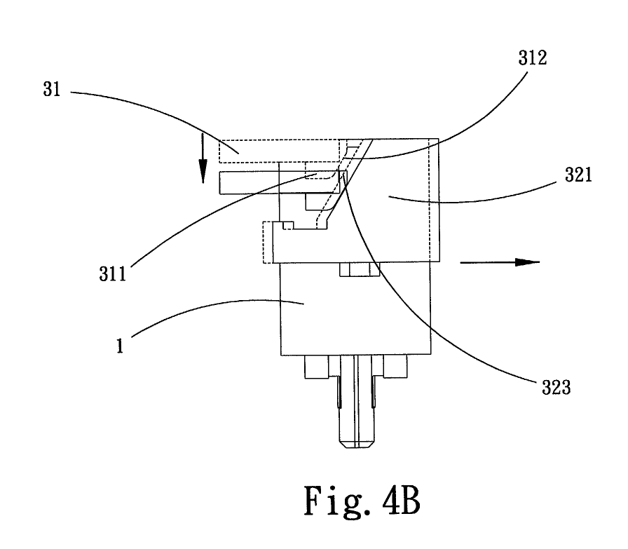

Referring to FIGS. 4A and 4B, when there is a desire to remove the interface card 4 from the latch slot 1, depress the depress ledge 31 downwards in an oscillating manner, and make the bucking stub 311 pressing against the bucking head 321 of the latch arm 32. The second chamfer surface 312 pushes against the first chamfer surface 323, and moves the latch arm 32 oscillating outwards. As a result, the retain strut 322 is moved away from the second latch end 42 and releases the harness condition of vertical movement from the interface card 4. Thus the interface card 4 may be depressed slightly sideward to disengage the first latch end 41 from the retain section 2, then be moved upwards by force to be freed from the latch slot 1.

While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A slot connector equipped with a retain structure comprising a retain section and a latch means located respectively on two ends of a slot;
wherein the latch means includes a depress ledge and a latch arm extending respectively from two sides of one end of the slot, and a latch slot located between the depress ledge and the latch arm, the latch arm being movable by the depress ledge.

2. The slot connector equipped with a retain structure of claim 1, wherein the depress ledge and the latch arm are respectively formed in a cantilever fashion and have a desired resilient property.

3. The slot connector equipped with a retain structure of claim 1, wherein the depress ledge has a selected area for users to exert force thereon.

4. The slot connector equipped with a retain structure of claim 1, wherein the depress ledge and the latch arm have respectively a bucking stub and a bucking head corresponding to each other.

5. The slot connector equipped with a retain structure of claim 1, wherein the latch arm has a jutting retain strut located on one side thereof facing the latch slot.

6. The slot connector equipped with a retain structure of claim 4, wherein the bucking stub is jutting from a selected location of one side of the depress ledge facing the latch slot.

7. The slot connector equipped with a retain structure of claim 4, wherein the bucking head has a first chamfer surface of a selected gradient corresponding to the bucking stub, and the bucking stub has a second chamfer surface corresponding to the first chamfer surface.

8. The slot connector equipped with a retain structure of claim 5, wherein the retain strut has a biased surface of a selected gradient facing the latch slot.
